(19) United States
(12) Patent Application Publication
(10) Pub. No.: US 2013/0262169 A1
(43) Pub. Date: Oct. 3, 2013

(54) AUTOMATED CONTRACT MEDIATOR

(71) Applicants: Johannes P. Van Der Vyver, Bedfordview (ZA); Gregory Scott Smith, Watkinsville, GA (US)

(72) Inventors: Johannes P. Van Der Vyver, Bedfordview (ZA); Gregory Scott Smith, Watkinsville, GA (US)

(21) Appl. No.: 13/819,587

(22) PCT Filed: Jul. 29, 2011
(86) PCT No.: PCT/US11/45938

§ 371 Date: Feb. 27, 2013

Related U.S. Application Data
(60) Provisional application No. 61/369,755, filed on Aug. 1, 2010.

(51) Int. Cl. G06Q 10/06

(52) U.S. Cl. CPC G06Q 10/063114
USPC 705/7.14

(57) ABSTRACT

An automated contract mediation system that (a) accepts tasks and parameters associated with the tasks from a requesting entity including a commitment to review the deliverables once received, (b) enables the requesting and commitment to complete the tasks to another entity, (c) receives deliverables related to the task from the other entity, (d) presents the deliverables to the requesting entity, (e) receives acceptance or rejection of the deliverables and takes action accordingly. For instance, if the deliverables are rejected, a deviation report can be submitted through the system to the other entity. The system also can process change requests, generate meeting minutes and provide risk management assessments.

### CROSS-REFERENCE TO RELATED APPLICATIONS

This is national state application for patent being filed in the United States Patent Office under 35 U.S.C. 371 based on International Application No. PCT/US2011/045938 having an International Filing Date of 29 Jul. 2011 and claiming priority to the provisional application for patent filed in the United States Patent Office on Aug. 1, 2010, bearing the title of AUTOMATED CONTRACT MEDIATOR and assigned Ser. No. 61/369,755, which applications are incorporated herein by reference in their entirety.

### BACKGROUND

The present disclosure describes embodiments of productivity tools, contracts, business management systems, and business execution systems, and more particularly, the embodiments that relate to a computer system for contract mediated collaboration.

Collaboration, or people working together, is a critical component to any organization. This is especially true of knowledge workers. In task based collaboration, people either complete simple tasks (also referred to as projects, or jobs) by themselves (often for other people), or they break more complex tasks into smaller/simpler tasks, which they then either complete themselves, or ask another person to complete for them before a certain date. People use the results of completed tasks to complete other tasks, such as through combining the results to complete more complex tasks, or using the results as inputs to be able to complete more complex tasks. This is the ideal. However, often the work done to complete a task is either late, or the work done does not meet the requirements/expectations, or both. Accordingly, significant amounts of paper, time, and effort may be required to keep track of who needs to do what, when does it need to be done by, what rework is required, and dealing with the required rework. In an attempt to manage this collaboration, progress reporting and meetings are common to organizations. This in turn requires even more paper, time and effort. The difficulty and complexity of collaboration is compounded when people collaborate across organizations.

Therefore, it would be desirable to provide a solution that automates and streamlines the collaboration between people. In addition, it is desirable for such a solution to also provide an oversight of what people are working on, how well they deliver on their promises, and especially what is happening between people. Furthermore, such a solution should preferably integrate with other business systems.

### BRIEF SUMMARY

Methods, systems and an apparatus for automating contract mediated collaboration between people are described, including measuring how well they deliver upon these contracts, and providing feedback. People interact with the system through client devices, such as terminals, personal computers, handheld devices, etc. A person, process or system (hereafter also referred to as an initiator or requester) can, via the system, request that another person, process or system (hereafter referred to as the expert) accept responsibility by giving their word, or agreeing, or otherwise making a commitment that they will complete a well described task on or before a given due date and time. In some embodiments, the acceptance may also or alternatively include a certain budget amount and payment terms as well as other criteria. In turn, the initiator makes a commitment, such as by giving their word, or agreeing, to review how well the expert completed the task and provide the results of this review within a certain time after the expert submits their completed work for review. If the expert agrees, then the system captures this as a contract between these two entities. Once the work is complete, the expert submits documented proof of task completion, via the system, to the initiator. Thus, in some embodiments, the contract can merely identify the subtasks and the commitments related thereto. In other embodiments, the contract may be a complete legally binding contract including all pertinent clauses including, but not limited to, identity of consideration, party obligations, the bargain for exchange, performance criteria, the identification of activity or performance criteria that would result in a breach of the contract, remedies, choice of law, etc. An advantage of this configuration is that by having the expert enter into a contract with the initiator, it can create incentive in the expert to perform the commitments identified in the contract. The incentive can thus be created by the psychological pressure or “entering into a contract”, as well as the creation of legal recourse on the part of the initiator if the expert breaches the contract. The system also captures the submission date and time as a deviation from the agreed to due date and time, if any as well as any other pertinent deviations. After evaluating the submission, the initiator captures, via the system, the deviation between the submitted proof of task completed and the agreed to task description. If there is some level of deviation, the expert is prompted by the system to complete the task, (i.e., the address deviation(s)) and the above cycle of work and submission for review through the system is again repeated.

As such, it will be appreciated that some embodiments of the ACM can focus on the mediation and monitoring of a contract that includes one or more deliverables, milestones, performance obligations etc. It will further be appreciated that in other embodiments, the ACM can take on more of a project management focus in which a task is being performed and the system mediates and monitors the assignment and performance of the various subtasks that are required for the completion of the task, with each subtask being viewed as a separate contract between an initiator and a performer. And yet in other embodiments of the ACM, the system can be used to simply monitor a single task or contract between two entities.

Various embodiments of an automated contract mediator (ACM) include additional or alternative features such as allowing changes in a contract. For example, a change may include, as non-limiting examples, a change in the description, due date and time, or budget. Such changes are also mediated via the system.

In various embodiments of the ACM, the interface into the ACM can be task-centered, thus allowing a generalization from contract mediated collaboration, to a task centered personal productivity system.

Various embodiments of the ACM may also include the function of automating meeting minutes as an extension of contract mediated collaboration. Given the fact that meeting minutes can be comprised of feedback and associated discussions, decisions, progress on tasks from previous meetings, including task reviews, and new tasks, this feature folds nicely into the various embodiments. The ACM processes meeting minutes into tasks, and generates meeting minutes from the submitted proof of completions of tasks from a previous meeting in a series.

Various embodiments of the ACM may also be used to provide feedback, vender evaluation and risk management assessment information. Because the information captured by the ACM can quantitatively present an individual's performance, such as how well they meet their contractual commitments and how well their collaborators meet theirs, an exemplary ACM can be used to automatically assess and analyze risks based entities and task relationships. This information can be aggregated for equivalent representations for companies and other groups. Thus, such embodiments of the ACM that exploit such information can be viewed as a viable business management solution. These embodiments, as well as the above-listed features, aspects and functions will be more fully understood by reviewing the following figures, detailed description and claims.

### BRIEF DESCRIPTION OF THE SEVERAL VIEWS OF THE DRAWING

FIG. 1 is block diagram illustrating an exemplary environment for various exemplary embodiments of an automated contract mediator.

FIG. 2 is a simplified workflow diagram for contract mediated collaboration from the vantage point of the initiator.

FIG. 3 is a simplified workflow diagram for contract mediated collaboration from the vantage point of the expert.

FIG. 4 is a simplified workflow diagram for contract change management using a change request.

FIG. 5 is a simplified workflow for integrating meeting minutes as an extension of contract mediated collaboration.

FIG. 6 is a state diagram illustrating exemplary phases of operation for an exemplary embodiment of the automated contract mediator.

FIG. 7 is a functional block diagram of the components of an exemplary embodiment of system or sub-system operating as a controller or processor 700 that could be used in various embodiments of automated contract mediator and/or components thereof.

### DETAILED DESCRIPTION OF EMBODIMENTS

The present disclosure presents embodiments, as well as aspects, functions and features of the various embodiments of an automated contract mediator that manages collaboration between people, processes and/or systems. Various embodiments of the automated contract mediator can be based on the assumption that if one entity (i.e., the expert) agrees to complete a task according to a description, before a given due date and time, then that entity has entered into a contract with the entity that requested this of them (i.e., the initiator). As part of the contract, the entity who sent the request (i.e., the initiator) commits to review the work completed, within a certain time window after completion.

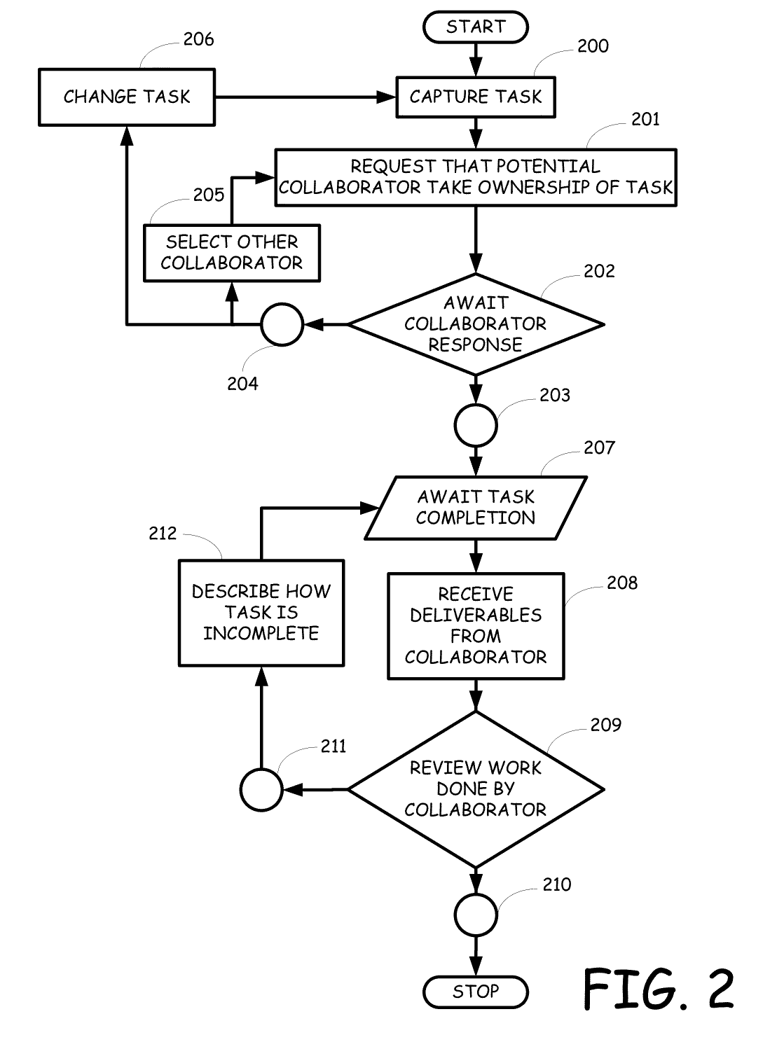

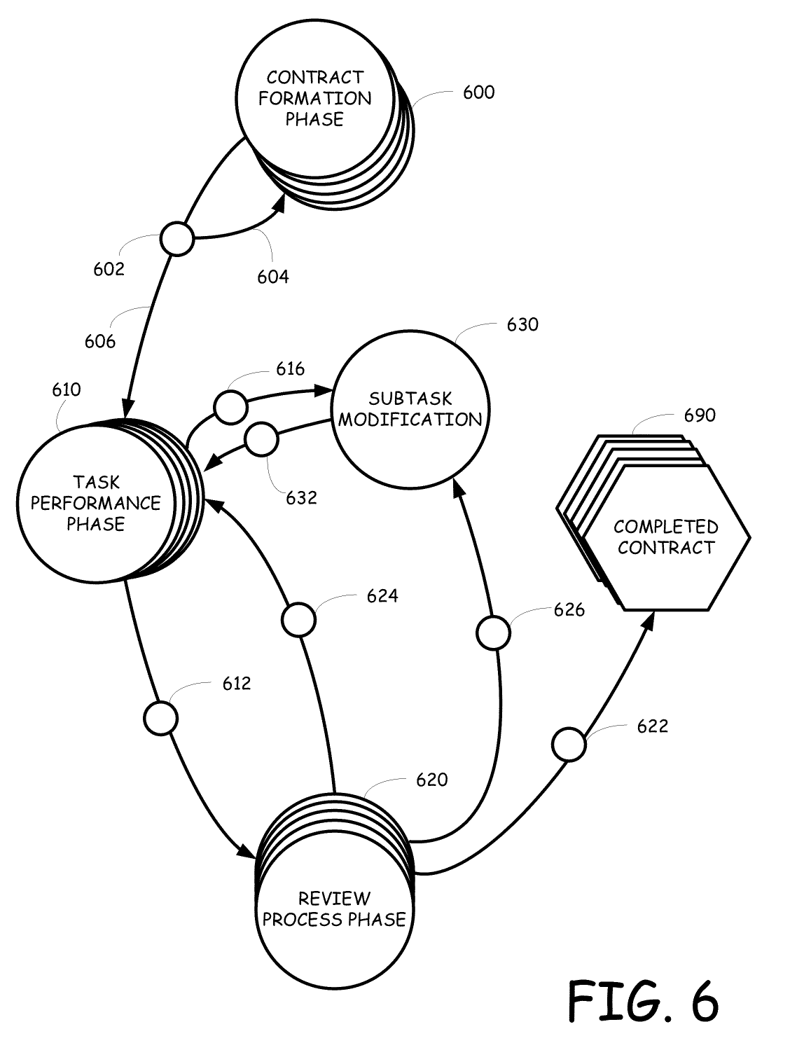

Various embodiments of the automated contract mediator may work on a contract specific basis to automate the process of monitoring contact requirements, completion, review, acceptance, etc. FIGS. 2-5 are flow diagrams illustrating actions of various tasks in exemplary embodiments of the automated contract mediator and will be presented in more detail below. However, an overall view of the operation of an exemplary embodiment of the automated contract mediator can be appreciated by examining a state diagram prior to addressing such details. FIG. 6 is a state diagram illustrating exemplary phases of operation for an exemplary embodiment of the automated contract mediator. As a non-limiting example, in one embodiment, during a contract formation phase 600, the automated contract mediator can accept initial settings, such as a task name, one or more subtask names that make up the task, description and due date and time from an initiator or otherwise provided. It should be appreciated that the term initiator, as used within this document, may refer to a user of the system or, another system that is being used to control or operate the automated contract mediator, such as a process, application, other system, etc. It should also be appreciated that the terms task and subtask may be used interchangeably but, that overall, the automated contract mediator manages various subtasks that are associated with or are a part of an overall task. In such an embodiment, once the initial settings are loaded, the initiator can then identify or select one or more experts to perform all or portions of the task or subtask. These experts can in turn, break their subtasks into various other subtasks or milestones and acting as initiators in turn select other experts for these subtasks or milestones. The expert or experts can be selected from a list of available experts, the results of a query, the results of an internet search, the results of a database lookup accessed based on the content of the initial settings or, simply by using a unique identifier for a particular expert. The identity of the expert can thus be obtained from an expert source, which may include a variety of different sources including databases, web searches, input information, as well as a combination to two or more of these and other sources, and the source can be accessed in an effort to find matching qualifications of available experts in view of various parameters that are associated with or included with the subtask. The initiator can then enter a time review window into the system. The illustrated embodiment shows multiple contract formation phases. For the overall task, multiple contracts may be formed with each contract being focused on one or more subtasks. The contracts may run independent of each other or may have various interdependencies.

At this point, the exemplary embodiment of the automated contract mediator may then present a request to the one or more experts 602, with each request identifying the initiator as the originator of the request. The request has the effect of soliciting an acceptance by an expert to complete the identified subtask according to the description, before the due date and time. The expert, which again may be an individual or a device/system operating on behalf of the expert, responds to the request by interfacing to the automated contract mediator. In some embodiments, the expert may either decline 604, or accept 606, the request. In other embodiments, additional options may be available such as, requesting more information, providing counter proposals, providing suggestions to alter the time or description of the tasks, etc. If the expert accepts the request, a contract is entered into between the initiating entity and the expert entity (which may be individuals, companies, organizations, etc.).

Once the contract is entered into, the expert can begin a task performance phase 610. It should be appreciated that the automated contract mediator presents the commitments in the contract as a task to the contracting entity. Thus, the automated contract mediator can manage all the complexity around the contract until the initiator approves of the work performed by the expert and the deliverables received. For instance, if the contract includes payment schedules, if commitments are contingent on other subtasks or activities, if the contract requires the delivery of certain information or materials to the expert, if notice obligations are required, or the like, the automated contract mediator can handle all of the administrative tasks associated therewith. Advantageously, this aspect of the automated contract mediator greatly reduces the complexity and procedural overhead for the entity.

In the illustrated state diagram, the task performance phase is shown as consisting of multiple subtasks. In actuality the number of subtask can range from one to as many as are necessary depending on the size and complexity of the overall task. As such multiple task performance phases can exist concurrently and be at different stages, committed to by one or more different experts, complete and begin at timings that may be independent from each other, interdependent on one or more other task performance phases, dependent upon all other task performance phases or classes of phases, etc. There can be a one-to-one correspondence between the contract formation phases and the task performance phases or, the relationship may be one-to-many or many-to-one as well. In each task performance phase, the expert performs the necessary actions to complete the described subtask. After the expert has completed the subtask, the expert submits documented proof of the completion of the subtask via the automated contract mediation system 612. The submitted documentation is then provided to the initiator.

Upon submission of the documents establishing completion of the task, a review process phase is entered 620. The illustrated embodiment shows multiple review process phases. Depending on the particular embodiment and the nature of the task, there can be a one-to-one correspondence between the various task performance phases and the review process phases, or there can be a one-to-many or a many-to-one correspondence as well. The time review window setting is used to calculate a due date and time for the review process phase. The calculated due date and time is the deadline for the initiator to the review the proof of task completed. During this review process, the initiator compares the results submitted by the expert against the task description to determine if there is any deviation between the task description and the deliverables. Once the review is completed, the initiator responds via the automated contract mediator. If there is no deviation between the task description and the deliverables, or if the deviation is of no consequence to the initiator, the initiator may respond with an approval indicator 622. Once the approval indicator is submitted, the task is considered complete and thus, the contact for that particular subtask or group of subtasks is considered satisfied or complete. If there is a deviation between the task description and the deliverables, the initiator responds with a detailed description identifying each deviation or at least one or more of the pertinent deviations 624. The automated contract mediator then sends this description to the expert identifying the contract as still active with additional elements of task description remaining to be completed and thus reactivates the task performance phase 610 for this subtask. At this point of the task performance phase, the task completed submission and review process phase continues in the same above-described manner.

In some embodiments, if the deviation is insignificant, the initiator can partially approve the task. Advantageously, the ability to have partial approval can help to alleviate conflicts in a critical path scenario. For instance, in a critical path scenario in which the current task has other tasks that are dependent on the completion of the current task before they can be either advanced, completed or initiated, having the ability to partially approve a task while insignificant deviations are addressed or simply ignored allows the other tasks to be initiated, advanced, tended to, completed or begun. As a non-limiting example, a task can be partially approved if the deviation is small enough that all dependant tasks can be advanced, completed or initiated. In an embodiment that allows partial approval, the initiator can still respond with a detailed description of the deviation, along with the partial approval.

In should be appreciated that once an original contract has been initiated, there may arise circumstance in which changes or alterations to the original contract are necessary. Such changes or alterations may arise due to a myriad of reasons. To address such situations, embodiments of the automated contract mediator can include a change management function 630. The change management function 630 can be integrated within the automated contract mediator or, can be an independent application, utility, web application, system, etc., that is interfaced to by the automated contract mediator. With the change management function, change requests may be submitted by the expert and/or the initiator. For instance, while the expert is working on a task, either the initiator or the expert might request a change 616 of the other via the automated contract mediator. In an exemplary embodiment, the change request may include a change in the task description and a relativistic change in task due date and time. Once a change request is submitted, it is delivered to the other party. The other party may be given the options to either accept or decline the change request. If a change request is accepted, then other parameters of the contract may be changed accordingly. When the expert submits proof of a task being completed, all outstanding change requests are rejected by the system.

If the review process finds the deliverables to be acceptable, then the contract for that particular subtask is considered complete 622 and the handling of that contract halt 690. However, if the task is only partially approved, then the subtask modification function 630 can be invoked 626 to identify the shortcomings and outstanding requirements of the subtask deliverables and establish a new schedule prior to submitting back to the expert 632 and invoking the task performance phase.

Various embodiments of the automated contract mediator may include the ability to store an audit trail. The audit trail provides a record of all (or selected) interaction with the automated contract mediator. As a non-limiting example, the audit trail may record details, dates, etc. about contracts, change requests, submissions, other communications, and change management. This audit trail is valuable if an entity needs to remember what lead up to the current state of affairs, and especially if there is any disagreement between the parties affected by a contract mediated task.

Another feature that may be incorporated into various embodiments includes a budget feature. The budget feature can operate to allow a monetary amount to be identified for a particular contract or portions of a contract, such as milestones. The budget feature may include functions for identifying the monetary amount agreed to by the parties, the payout schedule, the triggers for requiring payout events, the period of time over which payment is to be made, the percentage split upon partial or full approval, etc. Change management or providing and processing change request in such an embodiment may then include receiving and processing a change in the budget amount.

Another aspect of various embodiments of the automated contract mediator is the incorporation of a task based interface which allows an integrated user-experience within a generic personal productivity system. For example, a user can create a task by entering relevant information into the automated contract mediator. In an exemplary embodiment, the minimum required information may include a name for the task, and a due date and time being set to “as soon as possible”, i.e., not a specific due date and time. A task can also be described in detail. A task can also have a specific due date and time. A task can be broken down into smaller tasks, or tasks can be created that need to be completed before the current task can be started. All of these actions create relationships between tasks that make reporting more salient. Tasks are presented back to the user sorted by due date and time, and filtered according to the set it belongs to (i.e., the set of uncompleted tasks). Tasks that are contracted between users are transparently integrated into this interface. For example, once the expert submits the proof of task completion, the automated contract mediator creates a new task for the initiator. The name of this new task can be prefixed with the word “review” or similar indicia, and can include a date and time calculated as the time of submittal plus the contracted review time window. The new task also juxtaposes, or is presented along with the proof of task completion and the task description. This is similar to how once the expert agrees to a task, that task is immediately presented with that entity's other tasks.

Another aspect that may be included in various embodiments of the automated contract mediator is utilizing a set of theoretic operations on task contexts to filter search results. For instance, a task can be associated with a label, or tag. All tasks associated with a label are referred to as a set. Tasks can similarly be associated with meetings, companies, persons, entities, etc. An example of a set of theoretic operations is, to ask the system to return all tasks associated with the union of “label a” and “company b”, but not “label c”, (i.e., all tasks which involve “company b” and has the “label a”, but not the “label c”). For instance, a person or entity can create a set, and name it in the automated contract mediator. A person or entity can associate a task with the defined set. The task is automatically associated with the sets the persons or entities involved are associated with, eg, the company they work for. The task can be automatically associated with the sets of another task, from within which this has been created. These sets, along with mathematical set theoretic operations, can now be used to filter search results.

Another aspect that may be included in various embodiments of the automated contract mediator includes the ability to measure, record and/or track the timing of when a party completes an action in view of when the contract states that the action was scheduled or expected to be completed. For instance, this aspect allows the automated contract mediator to keep track of the time difference between when an expert was contracted to complete a task and when the expert actually submitted the documented proof of task completion. Similarly, this aspect enables the automated contract mediator to keep track of the review results of the submitted documents. This aspect of the automated contract mediator can operate to track the time deviations as well as the detailed description of this and other variations. An expert is deemed to have kept its commitment if the corresponding initiator approved or partially approved of the expert's deliverables that the expert captured in the ACM on or before the date at which the expert committed. In some embodiments, whether an initiator's commitment to review is kept is measured solely on timeliness (i.e., if an initiator captures the result of their review in the ACM before the date they committed to, then they have kept their commitment). Similarly the ACM can also record the extent to which the entity was tardy. It should be appreciated that in some embodiments, in addition to the timeliness of the review by the initiator, additional obligations can be placed on the initiator for the review process. As a non-limiting example, the expert may have deliverables that are contingent upon further input from the initiator, such as provision of tolerances or design constraints. In such embodiments, the expert can present the assigned deliverables that can only be finalized upon the provision of the input from the initiator. As such, the review process may be staged by having an initial review, which will result in the provision of the further input, and then a final review upon reception and resubmission of the deliverables including the further input.

It should also be appreciated that in some embodiments, the occurrence of scheduled meetings may be incorporated into the delivery commitments. For example, the scheduled delivery dates for deliverables identified in the contract may be contingent upon and due upon, or due based on the time-relationship of the occurrence of a meeting (i.e., due at the meeting, due 30 days after the meeting, etc.) Thus, if the meeting is delayed or canceled, then the deliverable schedule can be automatically altered. In other embodiments, the productivity of the expert(s) can be divorced from the occurrence of meetings. For instance, if a meeting is cancelled or delayed, the delivery schedule remains the same. Further, it will be appreciated that other embodiments may utilized a combination of subtasks that are contingent upon a meeting or other deliverable and subtasks that are independent of meetings or other deliverables.

The measurements made and recorded can be aggregated across various contracts to allow an individual person or entity seeking contract work to have a representation of an expert's ability to meet their contract deadlines and deliver finished, quality work. Similarly, these measurements can also be presented back to the entities to regulate their behavior, and determine the impact of changes in behavior. In addition, it will be appreciated that these measurements can also be aggregated across sets of contracts to allow a similar representation for projects or companies.

Another aspect that may be included in various embodiments of the automated contract mediator is the conversion and presentation of the information gathered through automating contract mediation collaboration to create meeting minutes. Meeting minutes can be said to capture attendee feedback, decisions made by attendees, reviews of tasks completed by attendees, and the defining of tasks that attendees have to complete, usually for the next meeting. Thus, in such embodiments the automation of contract mediated collaboration can simply be extended to automate the generation of meeting minutes. Thus, embodiments of the automated contract mediator can be used to track, monitor and report meetings, such as project meetings. For example, a series of meetings is simply another set or project with which tasks can be associated. One person is typically identified as being responsible for these meetings. This person will be referred to as the chairperson. A non-limiting example can be used to illustrate this aspect or feature. A chairperson initially enters an agenda into the automated contract mediator. Together with an agenda, the automated contract mediator can compile the minutes of an upcoming meeting by collating the submitted proof of task completion of tasks that were identified and initiated as the result of one or more previous meetings. A designated person (hereafter referred to as the scribe) takes the minutes during the meeting. The minutes can subsequently be parsed by the automated contract mediator.

Feedback and decisions related to the various tasks are captured in the minutes by the scribe, and can simply be stored in a searchable database by and/or for the automated contract mediator. New tasks may have been captured in the minutes. Thus, the automated contract mediator can parse the meeting notes to identify notes that may be new subtasks and duties, deliverables, milestones, etc. associated therewith. The automated contract mediator may perform this function autonomously and/or in conjunction with input from the initiator, a chairperson a scribe, etc. Once the meeting is completed, the scribe can then submit the minutes to the chairperson via the automated contract mediator. The chairperson can then review the minutes for corrections and/or approval. In alternative realizations, the chairperson's approval can be assumed. Upon the chairperson's approval, the automated contract mediator sends out the tasks captured in the minutes to the respectively identified experts. For example, in this scenario the chairperson effectively becomes the initiator of tasks associated with a specific series of meetings set. The due date and time of these tasks is determined by the next meeting. It should be appreciated that extending this automation to include an attendance register is simple, and would allow another meeting set efficacy measure.

In some embodiments, if there is a change in the time of a previously scheduled meeting, then the automated contract mediator can handle or manage the impact on agreed due dates and times of tasks. For instance, the above-described change management mechanism could be employed to handle the impact of the time change. As a non-limiting example, in an embodiment of the automated contract mediator, if the chairperson moves the start time/date of the next meeting in a series to an earlier time/date, the automated contract mediator then operates to present change requests to anyone that may have tasks or action items that were scheduled to be completed prior to the next meeting. The change requests, among other things, solicit the individuals or entities to either commit to complete their agreed to tasks in time for the now earlier scheduled meeting, or to agree that their work will only be reviewed at a subsequent meeting.

Another aspect that may be included in various embodiments of the automated contract mediator is a risk management feature. For instance, the measurements of contract mediation collaboration can be used as input to a risk management engine to identify, address and possibly identify solutions to manage the risk. For example, one aspect of the risk management feature is to analyze information related to how well a person or entity delivers on their task related contracts. Using this information, a person or entity can manage the risks that they are exposed to based on the ability of the collaborators to deliver on their contracts. As a more detailed example, an entity that is managing a multi-task project may have a variety of tasks with various interdependencies. Based on one expert's past performance, when the tasks are entered into the automated contract mediator and experts associated with the tasks, the automated contract mediator may flag a particular risk associated with a particular task. For instance, if the particular task is on the critical path and the associated expert, although having a history of providing cost effective and high-quality work product, has a track record of being late, the task can be requested of a different expert and, a different task (i.e., one that is not on the critical path) may be requested of the particular expert. As such, the risk analysis function may include a set of parameters that are monitored, such as the performance characteristics of an expert. As non-limiting examples, the performance characteristics may include historical timeliness, efficiency, budget adherence, technical expertise, product quality, etc. Each of these parameters can be assigned weights. In addition, each subtask can include information that identifies requirements for that subtask such as, time constraints (i.e on the critical path), maximum costs, allowed tolerances in quality, technical areas, etc. Each of the subtasks can be analyzed for each prospective expert and a weighted risk score can be attributed to particular expert and subtask parings. If the risk score is above a threshold amount, the risk analysis function can prevent, flag as potential problems and/or identify has high risk such expert and subtask pairings.

Similarly, embodiments of the automated contract mediator can monitor the various contracts, deliverables, performances, etc. involved in a particular task, as well as across multiple tasks. Further, the automated contract mediator can analyze, synthesize or otherwise review the results of this monitoring process and generate reports, analytical data or otherwise provide feedback with regards to how well an entity keeps its commitments, exceeds or falls short of performance standards, the quality of the deliverables, or the like. This analysis can be performed on a per entity basis, on an entity to entity basis (i.e., how well two entities work with each other), on a technology basis (i.e., how well an entity or set of entities perform in one technology area versus another technology area), as well as other criteria. This information can be used to gauge productivity, and similarly the effect of changes in behavior of entities. Such embodiments may also aggregate this information to show or identify parametrical data such as (a) the effectiveness of entities or certain leaders or personal associated with or working within the entity, (b) the effectiveness of meetings (c) the effectiveness of various departments, companies, groups of individuals or individuals, (d) how well two groups, departments, companies or entities keep their commitments to each other, etc. Such data can be invaluable in putting together teams for working on various tasks. For instance, if Company A indicates a high performance standard when it has to operate with or interact with Company B but, the performance standard is greatly reduced when operating or interacting with Company C, then the automated contract mediator can identify an issue that exists when Company A and Company C are paired together. Further, if Company C performs below standard when it is paired with any other entity other than Entity 1, and in such scenarios Company C is extremely effective, the automated contract mediator can then suggest that Company C is sent requests for tasks on when Entity 1 is involved. Thus, it will be appreciated that the assimilated data can advantageously assist in the structuring of teams to complete a task that can minimize risk, schedule delays and costs associated with a task. Thus, such embodiments of the automated contract mediator system then can operate to aggregate data reflective of the performance of the experts, analyze the aggregated data to identify performance results based on conditions in which a particular expert operates (i.e. types of subtasks, interaction with other entities, scheduling constraints, meeting frequencies, etc.), and utilizing the results of this analysis, the automated contract mediator can structure teams or control the creation of teams for other tasks or subtasks.

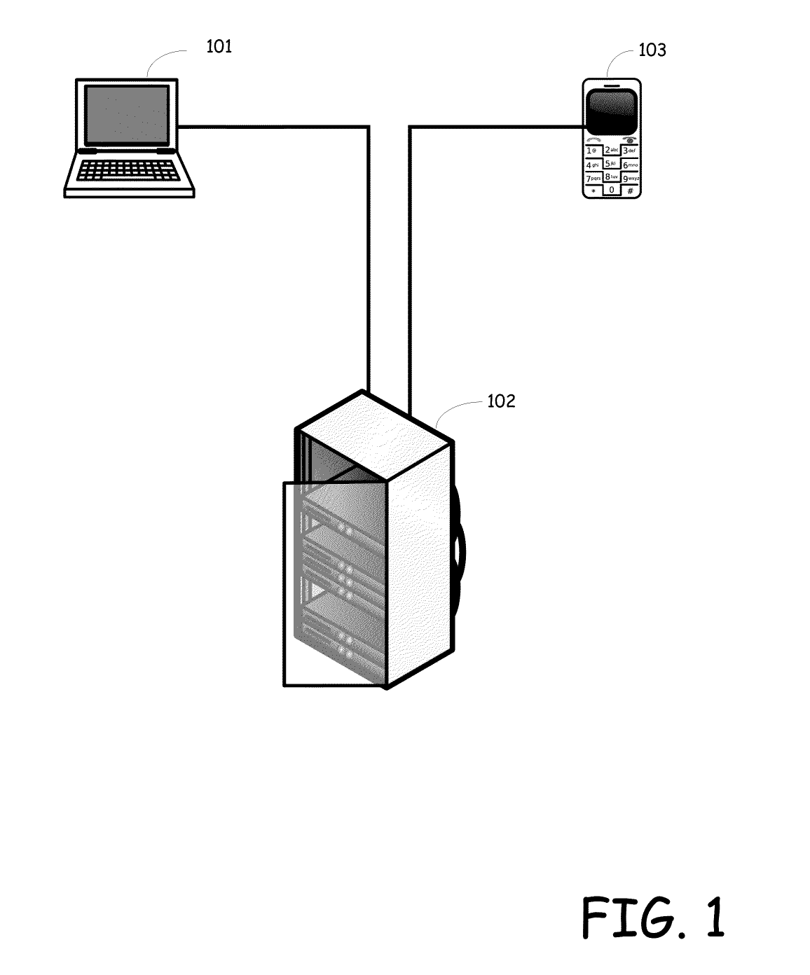

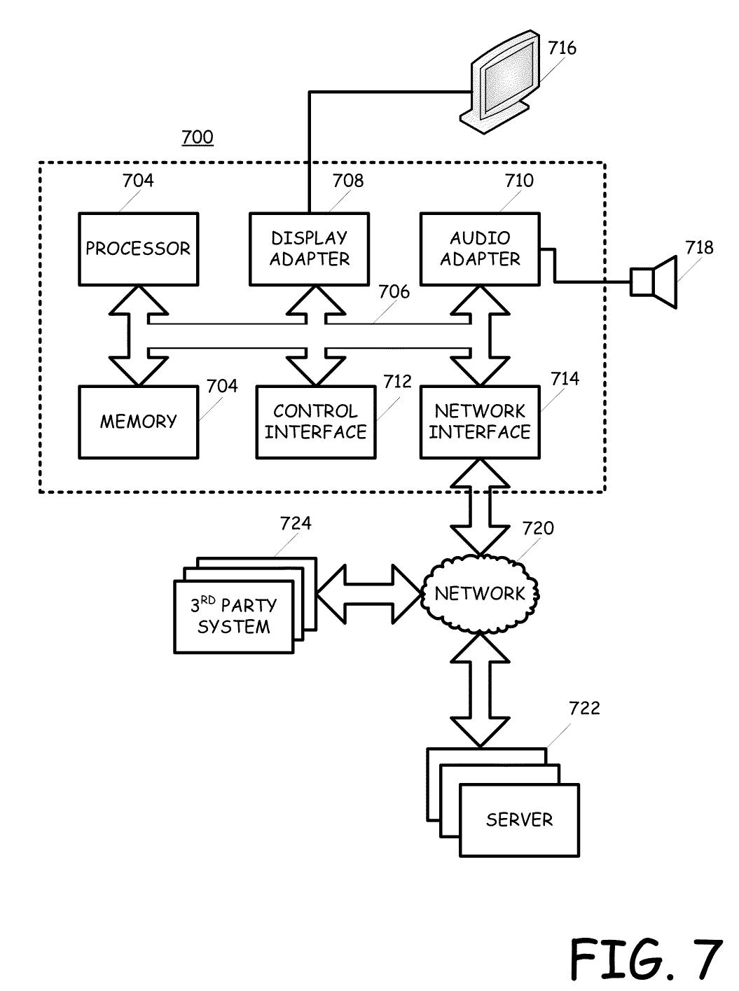

FIG. 1 is block diagram illustrating an exemplary environment for various exemplary embodiments of an automated contract mediator. A user access point 101, which may include a personal computer, a dumb terminal, a thin or fat client, a PDA, a mobile device or any of a variety of other computing platforms, interfaces to the main system 102. The main system may include a processor, memory, control circuitry, disk storage and any of a variety of other components that are typically associated with server type systems including network adapters, etc. In addition, a mobile or portable handheld device 103 may also interface to the main system 102. Using either the user access point 101 or the portable handheld device 103, the main system can be accessed for creating and initiating tasks, providing proof of task completion reports, reviewing proof documents, submitting change requests, submitting deviations, etc. Thus, one embodiment of the automated contract mediator may resides on a server system that includes a structure similar to what is presented in FIG. 7 and that interfaces to one or more external systems such as a user interface computer, the internet, databases, etc. In other embodiments, the automated contract mediator may be a software system that resides upon and executes within a single hardware platform, a distributed platform, a web application or the like.

FIG. 2 is a flow diagram illustrating actions taken in a task creation and sending operation of an exemplary embodiment of the automated contract mediation system. The task is initially captured 200 by the initiator entering particular parameters. The automated contract mediator requests a potential collaborator to take ownership of the task 201, here referred to as an expert. The response of the expert is waited for 202 and once received, the automated contract mediator acts on the response. If the task is declined 204, the system either autonomously or in conjunction with the initiator, selects another expert 205 and the actions continue at block 201. If instead the expert accepts the task 203, then a loop is entered to await completion of the task 207. If deliverables are received from the expert 208, the deliverables are reviewed by the initiator 209. If the task is complete 210, the task creation and sending process is completed. If the task if not complete 211, then a description of the deficiencies or deviations of the deliverables from the defined contract task is provided 212 and, processing continues at block 207 to again wait for the completion of the task.

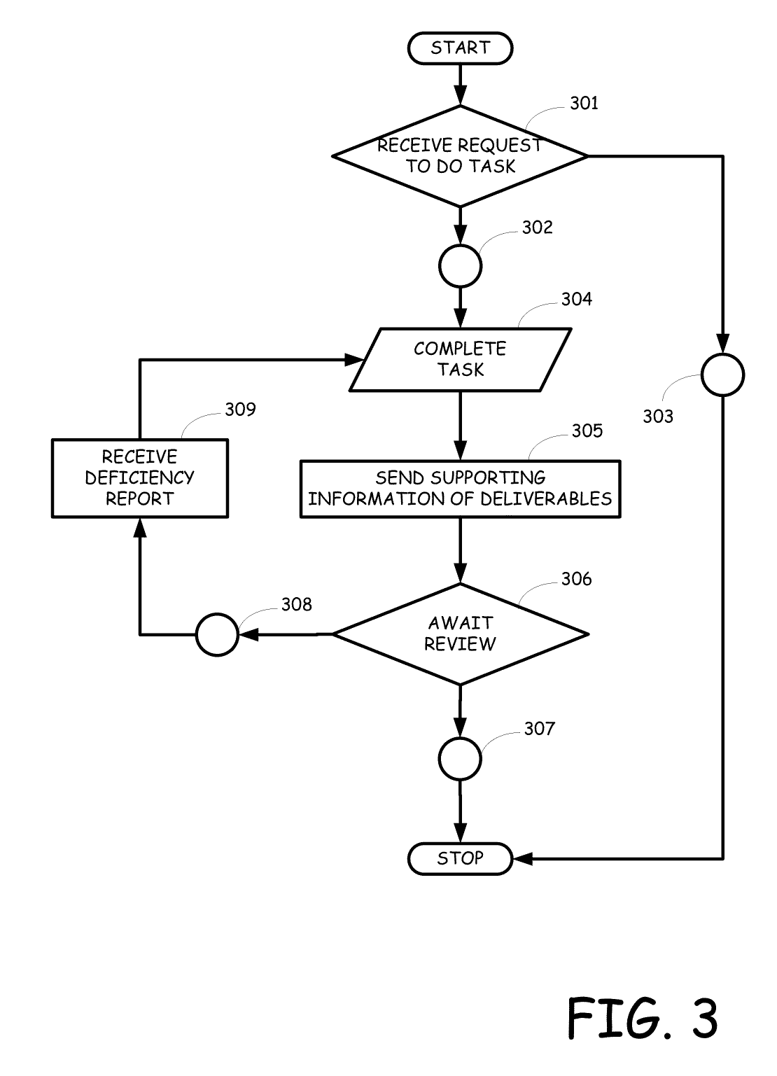

FIG. 3 is a flow diagram illustrating actions taken in a request to perform a task, such as what would be sent to an expert at action block 201 of FIG. 2. Initially, the expert receives the request to accept and perform a task 301. If the expert declines the task request 303, then the request to perform a task process or module is completed and the automated contract mediator may then select a different collaborator (see action block 205) and send a request to the newly identified expert. If the collaborator accepts the task 302, the collaborator performs the necessary actions and then ultimately completes the task 304. Upon completion, the expert sends the supporting information to establish proof of task completion 305. The system then awaits the results of the review of the deliverables by the initiator 306. If the deliverables are accepted 307, then the task is identified as being completed and approved. If the deliverables are not accepted 308, then the expert receives a description of the deficiencies of the deliverables and what needs to be done, corrected or augmented to satisfy the contract requirements 309. Processing then continues in the loop 304 to await another submission of completion of the task.

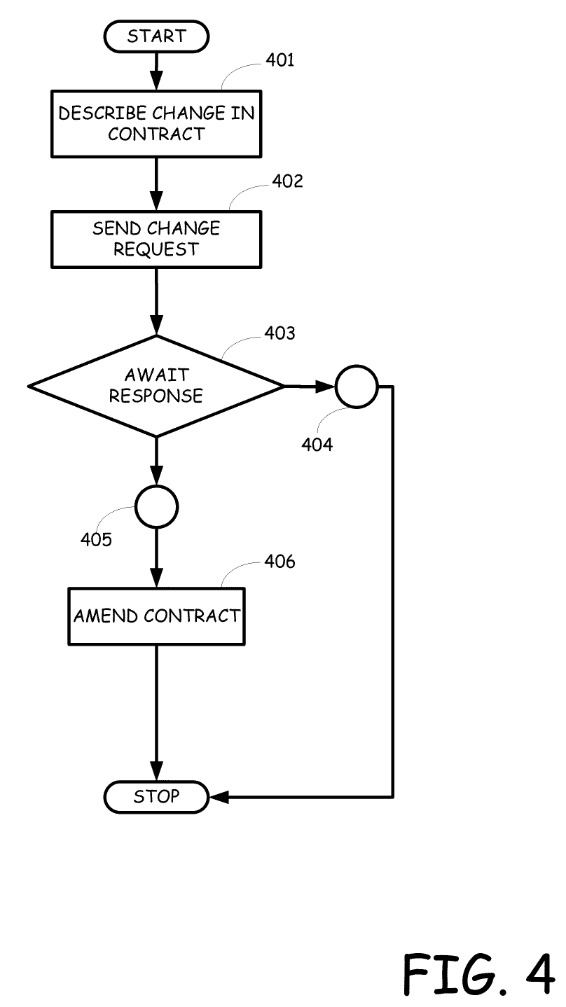

FIG. 4 is a flow diagram illustrating actions taken in a request to change parameters or details of an existing contract. Initially, the change request is created to describe the desired or necessary changes to the contract 401. The change request is then sent by the submitter to the collaborator via the automated contract mediator 402. The submitter then waits for a response from the collaborator 403. If the changes proposed in the change request are denied 404, the contract continues in its previous state. If the changes proposed in the change request are accepted 405, the contract is amended and any deliverables, due dates, costs, etc. are adjusted accordingly 406.

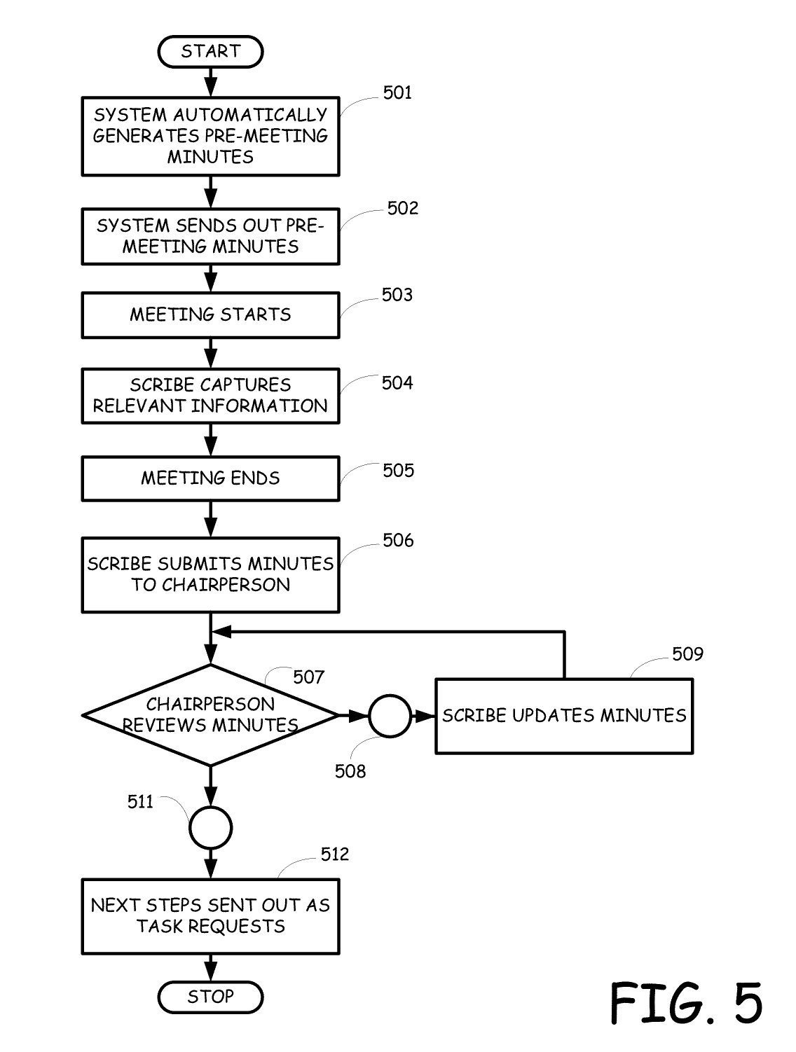

FIG. 5. is a simplified workflow diagram illustrating exemplary actions in a automated contract mediator that integrates meeting minutes as an extension of contract mediated collaboration. The automated contract mediator automatically generates pre-meeting minutes a certain time before the meeting starts 501. To prepare the meeting minutes 501, the automated contract mediator needs to have access to a set of information. This information can be accessed from a database or other system/application, input by a user or otherwise obtained. As a non-limiting example, the information provided to the pre-meeting notes generator may include any or all of the following information items, as well as other information items: (a) the meeting series, (b) all the outstanding tasks associated with the meeting series (if any) associated with this meeting, (c) the invitees of this meeting, (d) when the next meeting in the series is, (e) the agenda of the meeting, (f) the decision register of the meeting series, (g) the chairperson, (h) the scribe, (i) minutes from prior meetings, (j) schedules of attendees, etc. The pre-meeting minutes can be comprised of an agenda, with the attendees listed, the proof-of-previous next steps completed (or lack thereof) shown along with the respective previous next steps associated with this meeting, and a decision register.

Once the pre-meeting minutes are created, the system can then send out the pre-minutes to all the invitees 502. This may also include a meeting notice and a request to accept. At the scheduled time, the meeting starts 503.

Using the pre-meeting minutes as a template, the scribe captures the relevant meeting information 504. The scribe can capture who is present or absent during the meeting. The scribe can add agenda items based on the requests of the attendees. The automated contract mediator minutes the progress on previous tasks from the meeting series, i.e., the automated contract mediator minutes the state of previous tasks at the time of the meeting, which can include presenting all relevant information about the task. The scribe can capture new tasks from the meeting on behalf of an initiator. The scribe must select an expert for this task, describe the task, and can amend the due date and review window proposed by the automated contract mediator. A reasonable proposal for the due date and the review window presented by automated contract mediator would result in the task being completed and reviewed before the next meeting if the entities keep their commitments. The scribe can capture any decisions taken by the meeting attendees. The scribe can capture the feedback given, as well as, discussions during the meeting, and link to any relevant supporting information. In an embodiment of the automated contract mediator, the scribe can capture the above directly via a specialized system user interface, or in another embodiment the scribe can capture the above using a word processor. If a word processor is used, the scribe submits the electronic document to the automated contract mediator, which the automated contract mediator then parses so that the equivalent information is extracted as if the specialized system user interface was used. It will be appreciated that other mechanisms may also be employed for capturing the meeting notes including voice to text detectors, shorthand translators, court reporting systems or the like. Note that taking minutes for the meeting is a task within the automated contract mediator, ie, by capturing the meeting minutes the scribe is completing a task he or she has committed to do.

After the meeting ends 505, the scribe submits the meeting minutes 506, via the automated contract mediator, to the chairperson for review 507 as proof of task completion (the automated contract mediator creates a review task for the chairperson). If the chairperson indicates any errors or omissions 508 in the meeting minutes, the automated contract mediator creates a task for the scribe to update the minutes accordingly. The scribe updates the minutes 509, and resubmits the meeting minutes as a proof of task completion. The cycle now restarts from block 507. Should the chairperson accept the submitted meeting minutes 512, the automated contract mediator sends out the new next steps from the minutes as task requests to experts on behalf of the initiators. These requests are treated like all other requests by the automated contract mediator. If the scribe and the chairperson is the same person, then the cycle can be simplified by the automated contract mediator assuming the chairperson automatically accepts the minutes. In alternative embodiments, the chairperson's acceptance can be assumed, since the meeting minutes will be reviewed in the next meeting. Note that the task requests are requests captured on behalf of initiators, and are associated with the meeting series.

FIG. 7 is a functional block diagram of the components of an exemplary embodiment of system or sub-system operating as a controller or processor 700 that could be used in various embodiments of automated contract mediator and/or components thereof.

It will be appreciated that not all of the components illustrated in FIG. 7 are required in all embodiments of the automated contract mediator or its components but, each of the components are presented and described in conjunction with FIG. 7 to provide a complete and overall understanding of the components. The controller can include a general computing platform 700 illustrated as including a processor/memory device 702/704 that may be integrated with each other or, communicatively connected over a bus or similar interface 706. The processor 702 can be a variety of processor types including microprocessors, micro-controllers, programmable arrays, custom IC's etc. and may also include single or multiple processors with or without accelerators or the like. The memory element of 704 may include a variety of structures, including but not limited to RAM, ROM, magnetic media, optical media, bubble memory, FLASH memory, EPROM, EEPROM, etc. The processor 702, or other components in the controller may also provide components such as a real-time clock, analog to digital convertors, digital to analog convertors, etc. The processor 702 also interfaces to a variety of elements including a control interface 712, a display adapter 708, an audio adapter 710, and network/device interface 714. The control interface 712 provides an interface to external controls, such as sensors, actuators, drawing heads, nozzles, cartridges, pressure actuators, leading mechanism, drums, step motors, a keyboard, a mouse, a pin pad, an audio activated device, as well as a variety of the many other available input and output devices or, another computer or processing device or the like. The display adapter 708 can be used to drive a variety of alert elements 716, such as display devices including an LED display, LCD display, one or more LEDs or other display devices. The audio adapter 710 interfaces to and drives another alert element 718, such as a speaker or speaker system, buzzer, bell, etc. The network/interface 714 may interface to a network 720 which may be any type of network including, but not limited to the Internet, a global network, a wide area network, a local area network, a wired network, a wireless network or any other network type including hybrids. Through the network 720, or even directly, the controller 700 can interface to other devices or computing platforms such as one or more servers 722 and/or third party systems 724. A battery or power source provides power for the controller 700.

Various embodiments of the ACM may interface with external systems and/or be integrated with external systems and/or may have other external systems/functionality integrated into the ACM. As a non-limiting example, the ACM may include an OUTLOOK interface module that can schedule deliverables, meetings or other elements of a contract by sending meeting requests or task assignments to the various experts OUTLOOK system. For instance, a request sent to an expert can be performed in the form of an OUTLOOK meeting request that can be accepted by the expert. Once accepted, the acceptance notice is then sent back to the ACM which completes the commitment to enter into a contract for the performance of the subtask. As another non-limiting example, the ACM may include an interface module for interacting with a project scheduling system such as PROJECTMANAGER, sold and marketed by Project Manager Online Ltd. In such an embodiment, the ACM can provide task and subtask information to the PROJECTMANAGER which can then generate a project schedule, identifying each assignment, the experts committed to each subtask, critical path of the task, etc. Further, modifications made to the project schedule through the PROJECTMANAGER can then be fed into the ACM for the generation of additional requests or modified requests to be sent out to one or more experts for commitment. In yet other embodiments, other applications can be incorporated into the ACM. For example a budgeting software application can be incorporated into the ACM to allow for accurate tracking of the budget of a contract or task as it progresses from commencement to completion. As information is assimilated, it can be determined if the task or contract is progressing in a manner that is within budget, under budget or exceeding budget. Advantageously, as such information is assimilated, changes can be entered into the budget software application, such as reducing budget allocation for certain subtasks and/or increasing budget allocations for other subtasks. This information can be directly ported into future assignment requests sent to experts, or in modification requests of previously sent and/or accepted assignments.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

In this application the words “process”, “unit” and “module” are used interchangeably. Anything designated as a process, unit or module may be a stand-alone unit or a specialized module. A process, unit or a module may be modular or have modular aspects allowing it to be easily removed and replaced with another similar unit or module. Each unit or module may be any one of, or any combination of, software, hardware, and/or firmware.

The various embodiments, as well as features, aspects and functions thereof, have been described using detailed descriptions of embodiments thereof that are provided by way of example and are not intended to limit the scope of the invention. The described embodiments comprise different features, not all of which are required in all embodiments of the automated contract mediator. Some embodiments of the automated contract mediator utilize only some of the features or possible combinations of the features whereas some embodiments may utilize or employ all described features. Variations of embodiments of the present invention that are described and embodiments of the present invention comprising different combinations of features noted in the described embodiments will occur to persons of the art.

It will be appreciated by persons skilled in the art that the present invention is not limited by what has been particularly shown and described herein above. Rather the scope of the invention is defined by the claims that follow.

What is claimed is:

1. A method for managing a task that can be broken down into one or more subtasks as contracts, the method comprising the actions of:
receiving input information at an automated contract mediator (ACM) from an initiating entity, wherein the input information identifies one or more subtasks associated with the task, parameters associated with the subtask, and a commitment to review the deliverables;
storing the input information into a memory element accessible by the ACM;
identifying an expert for performing one or more of the one or more subtasks by the ACM interfacing to an expert source;
sending a request from the ACM to the identified expert thereby requesting the identified expert to commit to one or more of the subtasks, the request at least partially based on the input information;
where the ACM captures the acceptance by the expert as a contract between the initiator and the expert for that particular task or subtask;
receiving deliverables at the ACM, the deliverables being related to the performance by the expert of the one or more subtasks;
presenting the deliverables to the initiating entity for review;
receiving review results at the ACM from the initiating entity, the review results indicating that the status of the one or more subtasks are in at least one of the states selected from the states of accepted and rejected;
if the status of the review results indicate that a particular subtask is rejected,
generating at the ACM a deficiency list identifying portions of the particular subtask that need to be addressed,
reassigning the particular subtask to the identified expert along with the deficiency list, and
continuing from the action of receiving deliverables related to the one or more subtasks from the expert, and
if the status of the review results indicate that the particular subtask is accepted, the ACM flagging the subtask as being completed and the contract concluded successfully.

2. The method of claim 1, further comprising the actions of:
creating an audit trail consisting of information identifying one or more of the actions that have occurred; and
storing the audit trail in the memory element accessible by the ACM.

3. The method of claim 1, wherein the status of the one or more subtasks can also include the state of partially approved and further comprising the action of, if the status of the review results indicate that a subtasks is partially approved, release other subtasks that are dependent upon the completion of the partially approved subtask to be initiated and resubmit the partially approved subtask to the expert for continued processing.

4. The method of claim 1, further comprising the action of:
receiving at the ACM an acceptance indicator from the expert in response to the request sent to the expert by the ACM thereby forming a contract for the performance of the subtask by the expert, wherein the contract is between the initiator and the expert.

5. The method of claim 4, further comprising the action of the ACM assigning a budget to be identified for the contract, the budget including one or more of the parameters selected from the group of parameters including: monetary amount to be provided for completion of the subtask, monetary amount to be provided for partial completion of the subtask, monetary amount to be provided for completion of a milestone identified in the subtask, payout schedule, triggers for invoking payout events, and period of time over which payout events are to occur.

6. The method of claim 1, further comprising the actions of:
the ACM associating one or more subtasks with a tag;
receiving at the ACM a query for all subtasks associated with the tag;
retrieve from memory the status information and task input information associated with each subtask that is associated with the tag; and
present the retrieved information to a user interface for review.

7. The method of claim 1, wherein the action of the ACM associating one or more subtasks with a tag further comprises associating the one or more subtasks with a meeting tag thereby indicating that the associated tasks are associated with a particular meeting.

8. The method of claim 1, further comprising the action of automatically creating meeting minutes for a meeting associated with a subtask.

9. The method of claim 1, wherein the action of automatically creating meeting minutes further comprises the actions of:
obtaining the meeting minutes in a format that can be parsed by the ACM;
parsing the meeting minutes to identify additional subtasks that must be completed;
storing information related to the additional subtasks into the memory accessible by the ACM; and
continuing from the step of identifying and expert for performing one or more of the additional subtasks by the ACM interfacing to an expert source.

10. The method of claim 1, further comprising a risk management function that includes the actions of:
monitoring the actions of receiving task input information and identifying an expert;
identify risks associated with certain subtasks in the task input information as it relates to particular experts; and
flag the subtask and expert pairings that have identified risks.

11. The method of claim 1, wherein the task input information identifies particular parameters of the subtasks and the expert source identifies particular performance characteristics of the experts, the method further comprising actions of:
analyzing prospective expert and subtask assignments based at least in part on the parameters of the subtasks and the performance characteristics of the experts;
assigning a risk score to particular expert and subtask parings;
if the risk score is above a threshold value, identify the particular expert and subtask pairing as being high risk.

12. The method of claim 1, wherein up the status of the review results of each subtask indicating that each subtask is accepted, the ACM flagging the contract as being completed.

13. An automated contract mediator system comprising:
a memory element;
a processor communicatively coupled to the memory element;
an interface for receiving and transmitting data and that is controlled by the processor,
the processor being configured to:
receive task input information received at the interface, the task input information being provided by an initiating entity and identifying a task comprised of a plurality of subtasks and parameters associated with each subtask;
store the task input information into the memory element;
access an expert source to identify and expert for performing one or more of the plurality of subtasks;
send a request to the identified expert to assign one or more of the subtasks to the identified expert, the request at least partially based on the task input information;
upon receiving rejection of the request from the expert, identifying an alternate expert and continuing from the send a request step;
upon receiving an acceptance from the expert,
identifying a contract for the expert to complete the subtask;
receiving deliverables from the expert for an assigned subtask;
presenting the deliverables to an initiating entity for review;
receiving review results from the initiating entity indicating that the status of the subtasks is accepted; and
flagging the subtask as being completed.

14. The automated contract mediator of claim 13, wherein the processor is further configured to:
determine that the status of the review results indicates that a particular subtask is rejected;
generate a deficiency list identifying portions of the particular subtask that need to be addressed;
reassign the particular subtask to the identified expert along with the deficiency list, and
continue from the action of receiving deliverables related to the one or more subtasks from the expert.

15. The automated contract mediator of claim 14, wherein the processor is further configured to:
determine that the status of the review results indicates that a particular subtask is partially approved;
release other subtasks that are dependent upon the completion of the partially approved subtask to be initiated; and
resubmit the partially approved subtask to the expert for continued processing.

16. The automated contract mediator of claim 15, wherein the processor further:
associates one or more subtasks with a tag;
receives a query for all subtasks associated with the tag;
retrieves from memory the status information and task input information associated with each subtask that is associated with the tag; and
presents the retrieved information to a user interface for review.

17. The automated contract mediator of claim 15, wherein the processor further includes a query engine that:
associates one or more subtasks with one or more tags;
receives a query identifying a function related to one or more tags;
retrieves from memory the status information and task input information associated with each subtask that has tag associations that satisfy the query; and
presents the retrieved information to a user interface for review.

18. The automated contract mediator of claim 15, wherein the task input information identifies particular parameters of the subtasks and the expert source identifies particular performance characteristics of the experts, and wherein the processor further includes a risk management function that:
analyzes prospective expert and subtask assignments based at least in part on the parameters of the subtasks and performance characteristics of the experts;
assigning a risk score to particular expert and subtask parings; and
if the risk score is above a threshold value, identify the particular expert and subtask pairing as being high risk.

19. An automated contract mediator system for assigning subtasks of a task and monitoring progress, wherein the commencement of at least one subtask is dependent upon the completion of another subtask, the system comprising:
a memory element;
a processor communicatively coupled to the memory element;
an interface for receiving and transmitting data and that is controlled by the processor,
the processor being configured to:
search an available experts source to find at least one expert that is suitable for completing each of a plurality of subtasks needed to be completed over the duration of the task, each subtask including scheduling information for its completion as well as expected deliverables;
for each identified expert send a request to the identified expert to assign one or more of the subtasks to that identified expert;
upon receiving rejection of the request from the expert, identifying an alternate expert and continuing from the send a request step;
upon receiving an acceptance from the expert for a particular subtask, thereby forming a contract for the completion of the assigned particular subtask,
receiving deliverables from the expert for an assigned particular subtask;
causing the received deliverables to be compared against the expected deliverables for the assigned particular subtask;
if the deviation between the received deliverables and expected deliverables is acceptable, flagging the subtask as being complete thereby allowing any subtasks that are dependent upon the completion of the assigned particular subtask to be started;
if the deviation between the received deliverables and expected deliverables is not acceptable, identifying the deficiencies and submitting back to the expert for completion of the assigned particular subtask.

20. The automated contract mediator system of claim 19, wherein the processor further:
associates each of the subtasks with one or more tags;
receives a query identifying one or more tags; and
retrieves from memory a status information associated with each subtask that is associated with the one or more tags.

21. The automated contract mediator system of claim 19, wherein at least one of the subtasks is a meeting and the processor further:
obtains meeting minutes from the meeting in a format that can be parsed by the system;
parses the meeting minutes to identify additional subtasks that must be completed over the duration of the task; and
searches a list of available experts to find at least one expert that is suitable for completing each of a additional subtasks needed to be completed over the duration of the task, each subtask including scheduling information for its completion as well as expected deliverable.
continuing from the step of identifying and expert for performing one or more of the additional subtasks by the ACM interfacing to an expert source.

22. The automated contract mediator system of claim 21, wherein each available expert in the expert source includes particular performance characteristics, and wherein the processor further includes a risk management function that:
analyzes prospective expert and subtask assignments based at least in part on the scheduling information and expected deliverables for the subtask;
assigning a risk score to particular expert and subtask parings; and
if the risk score is above a threshold value, identify the particular expert and subtask pairing as being high risk.

23. The automated contract mediator system of claim 19, wherein the processor is further configured to:
aggregate data reflective of the performance of the experts;
analyze the aggregated data to identify performance results based on conditions in which a particular expert operates; and
utilizing the results of the analysis for the identification of experts for additional subtasks or tasks.

24. The automated contract mediator system of claim 19, further comprising an interface to an external application that provides project management tracking functions.

25. The automated contract mediator system of claim 19, further comprising an interface to OUTLOOK for scheduling of subtasks and receiving the acceptance of assignments.
